(19) United States
(12) Patent Application Publication
(10) Pub. No.: US 2002/0097118 A1
(43) Pub. Date: Jul. 25, 2002

(54) Current actuated switch

(76) Inventors: James W. Siekkinen, Bay Village, OH (US); Chris Apanius, South Euclid, OH (US); Brad Boggs, Mentor, OH (US); Kevin Stark, Richmond Heights, OH (US); Xiaofeng Yang, Broadview Heights, OH (US); Christopher Bang, San Diego, CA (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/833,174

(22) Filed: Apr. 11, 2001

Related U.S. Application Data
(60) Provisional application No. 60/264,189, filed on Jan. 25, 2001.

(51) Int. Cl. H01H 51/22

(52) U.S. Cl. 335/78

(57) ABSTRACT

A switch including a first and a second conductor and a transducer. The switch includes a base and an actuator coupled to the base. The actuator includes an actuating surface and a coil located thereon such that when the switch is located in a magnetic field and a sufficient current is passed through the coil, the actuator is displaced relative to the base to an actuating position wherein the actuating surface causes the first and second conductors to be electrically coupled.

This application claims priority to provisional application Serial No. 60/264,189 filed Jan. 25, 2001, the contents of which are hereby incorporated by reference.

The present invention is directed to a switch, and more particularly, to a current-actuated micro-switch for transmitting radio frequency signals.

### BACKGROUND OF THE INVENTION

Switches are commonly used to control electrical connections between two or more conductors or signal lines. For example, in radio frequency (“RF”) systems, such as an array of antennas, RF signals are transmitted between various components, and a switch or plurality of switches are utilized to control transmission of the RF signals. Switches are also commonly used in multi-frequency communications or as a transmit/receive switch. Switches, including micro-switches, are also typically used with microelectromechanical systems (“MEMS”), including a wide variety of actuators and transducers such as accelerometers, flow sensors, pressure sensors, optical switches and the like, to control the operation of the MEMS devices and/or control the transmission of signals to and from the MEMS devices. Of course, switches in general are used to control the flow of current or transmission through any conductor or signal line.

Many existing micro-switches are electrostatic-actuated switches, which include an actuator that is moved by attractive electrostatic forces within the switch. However, the force generated by the electrostatic field inside such a switch decreases exponentially with distance. Accordingly, the actuator in an electrostatic switch must be located relatively close to the circuit that is controlled by the switch and only a small contact separation can be provided. Thus, because of the small contact separation, parasitic effects may be produced in the circuit and it may be difficult to achieve high-voltage isolation in a normally open contact state of the switch. Furthermore, existing switches may be difficult to manufacture, may have a slow response time or may lack robustness.

### SUMMARY OF THE INVENTION

The present invention is a switch that reduces parasitic effects, is easy to fabricate, has a quick response time and is robust. In particular, the switch of the present invention includes an actuator that is moved by electromagnetic forces, which thereby provides actuation forces that are relatively strong over relatively large distances. In one embodiment, the invention is a switch including a first and a second conductor and a transducer. The switch includes a base and an actuator coupled to the base. The actuator includes an actuating surface and a coil located thereon such that when the switch is located in a magnetic field and a sufficient current is passed through the coil, the actuator is displaced relative to the base to an actuating position wherein the actuating surface causes the first and second conductors to be electrically coupled.

Other objects and advantages of the present invention will be apparent from the following description and the accompanying drawings.

### BRIEF DESCRIPTION OF THE DRAWINGS

FIG. 1 is a perspective view of one embodiment of the switch of the present invention, with the top cap removed for illustrative purposes;

FIG. 1A is a perspective view of another embodiment of the switch of the present invention, with the top cap removed for illustrative purposes;

FIG. 2 is a perspective view of the transducer wafer of the switch of FIG. 1;

FIGS. 3-6 are top views of various embodiments of the actuator wafer that may be used with the switch of the present invention, showing various effective arm lengths;

FIG. 7 is a cross section taken along lines 7-7 of FIG. 1A;

FIG. 7A is the switch of FIG. 7 with the actuator in its actuating position;

FIG. 8 is a cross section of the switch of FIG. 1 taken along lines 7-7, including a top cap and magnet, and an alternate circuit;

FIGS. 9-23 are a series of side cross sections illustrating a sequence of steps that may be used to manufacture the actuator wafer of FIGS. 7, 7A and 8;

FIGS. 24-27 are a series of side cross sections illustrating a sequence of steps that may be used to form the circuit wafer of FIGS. 7 and 7A; and

FIGS. 28-36 are a series of side cross sections illustrating a sequence of steps that may be used to form the circuit wafer of FIG. 8.

### DETAILED DESCRIPTION

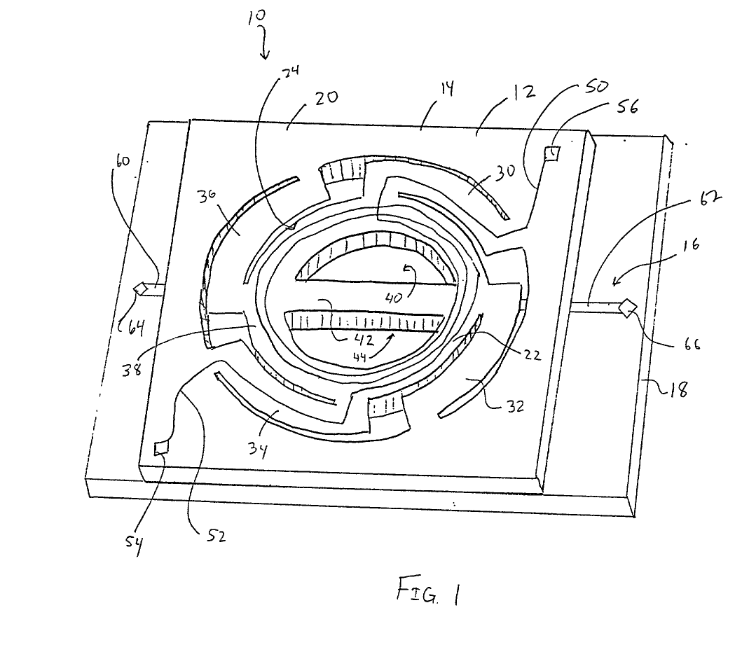

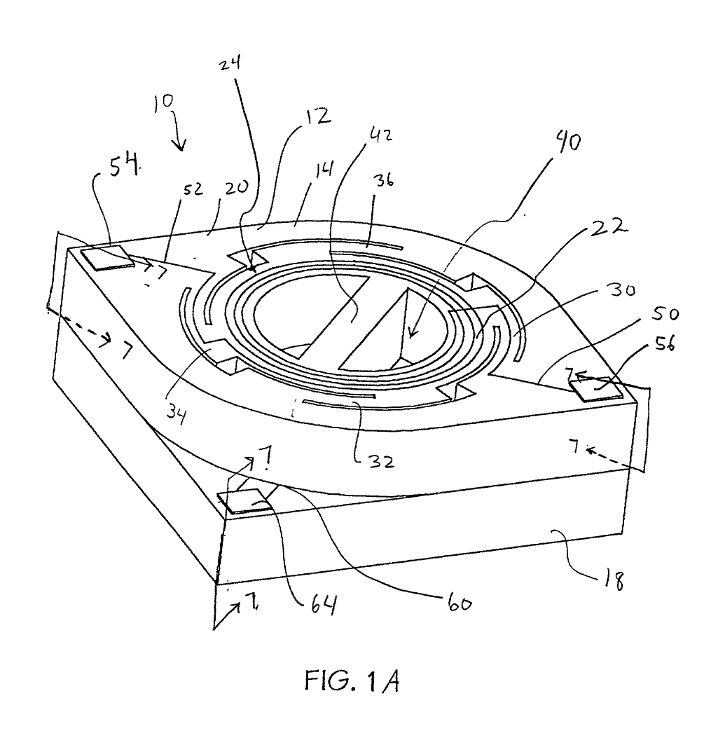

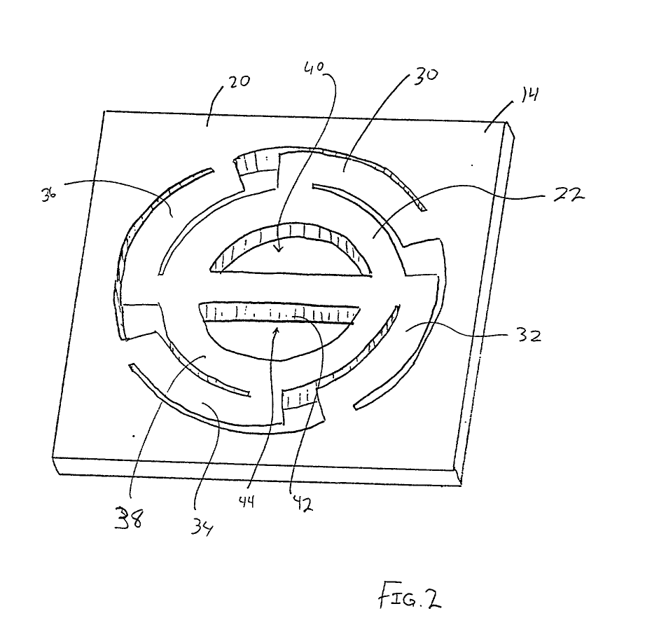

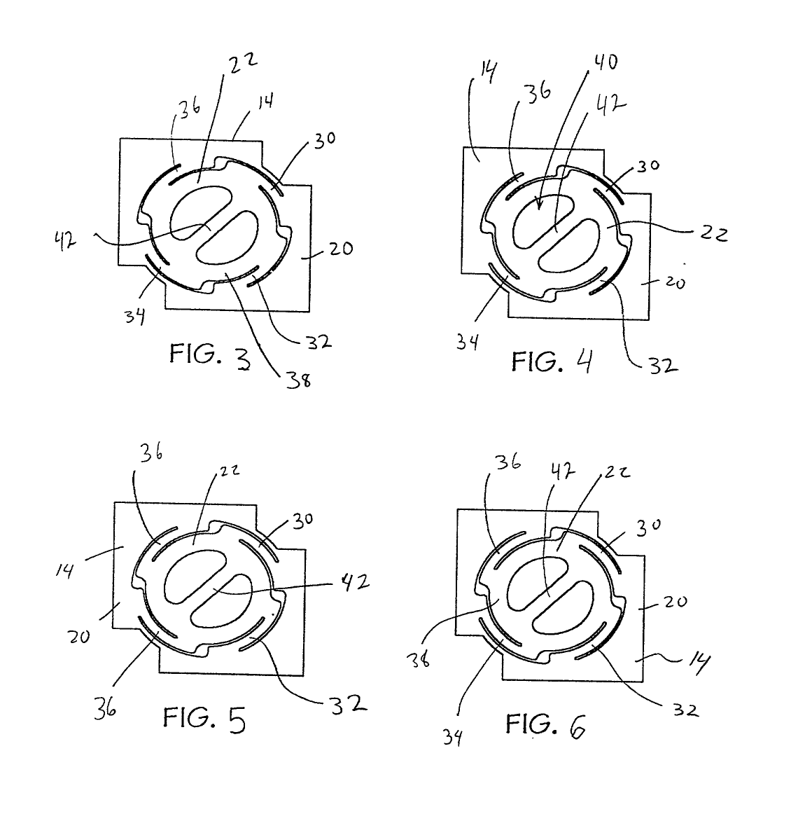

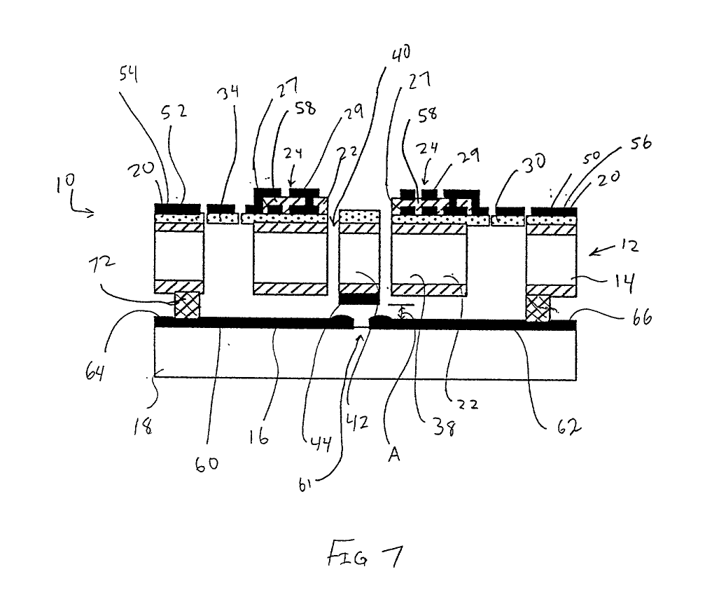

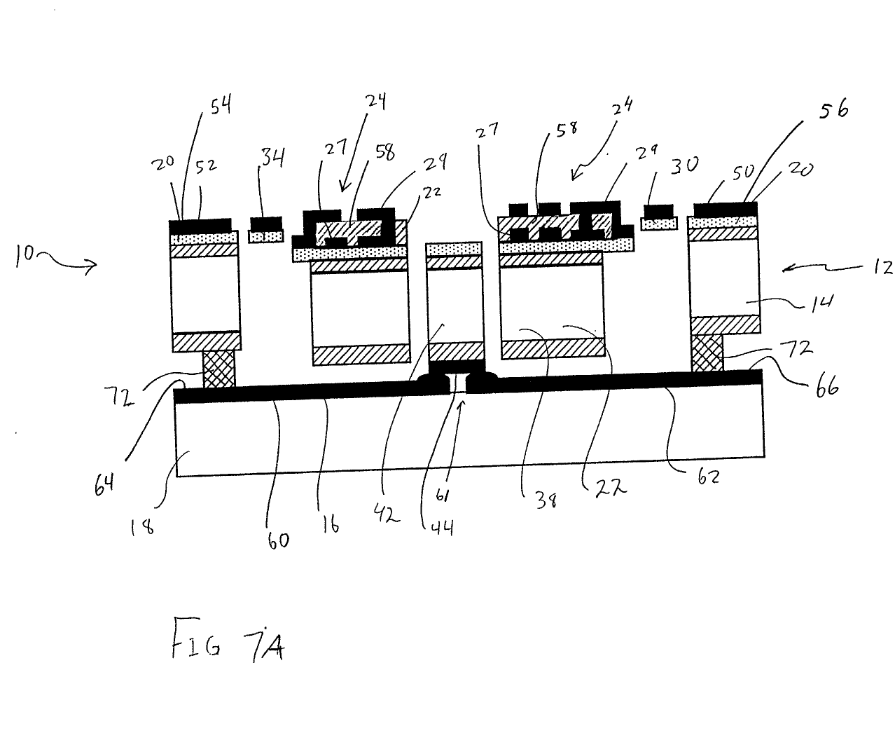

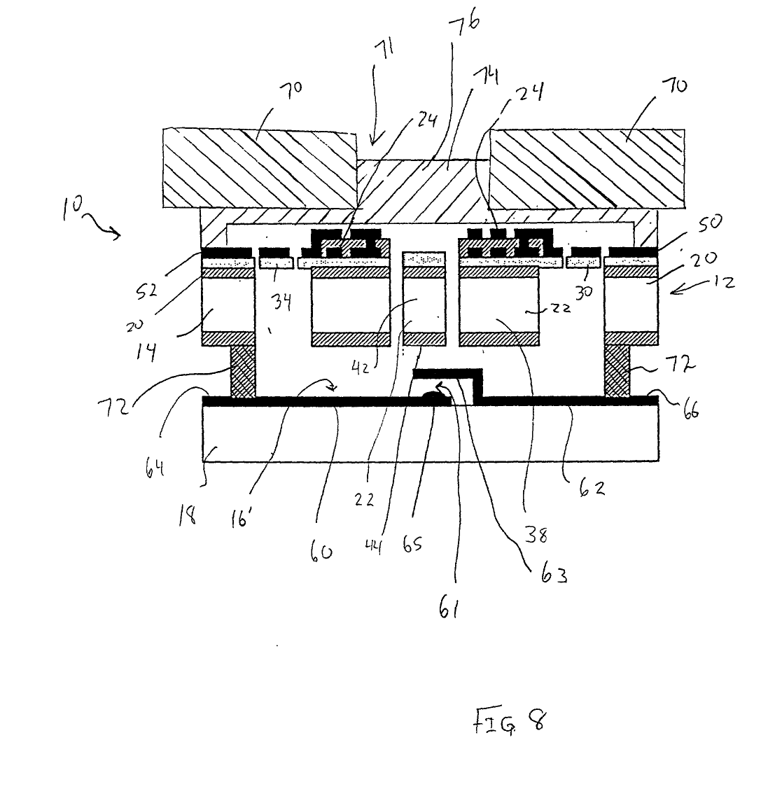

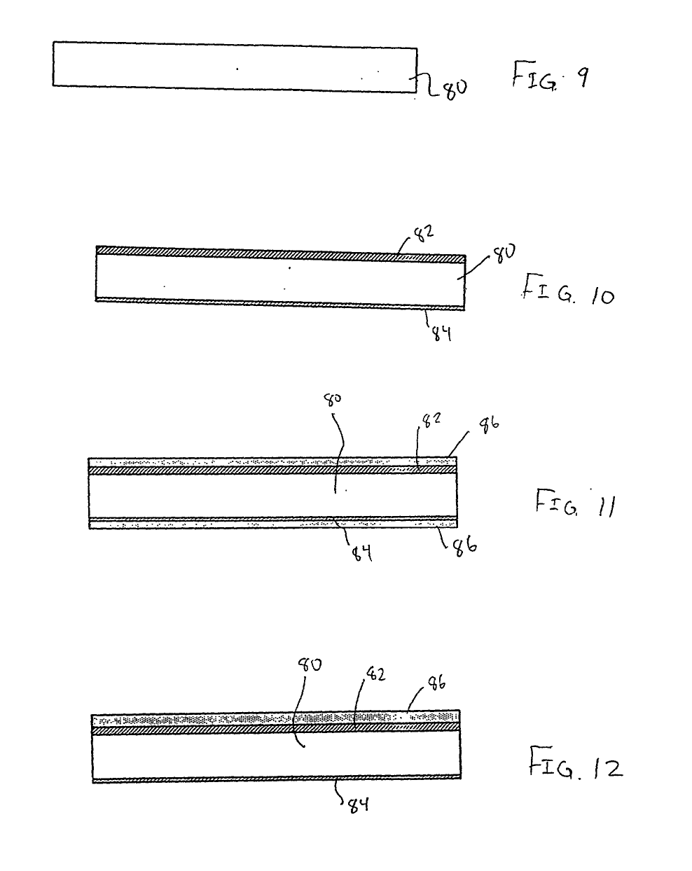

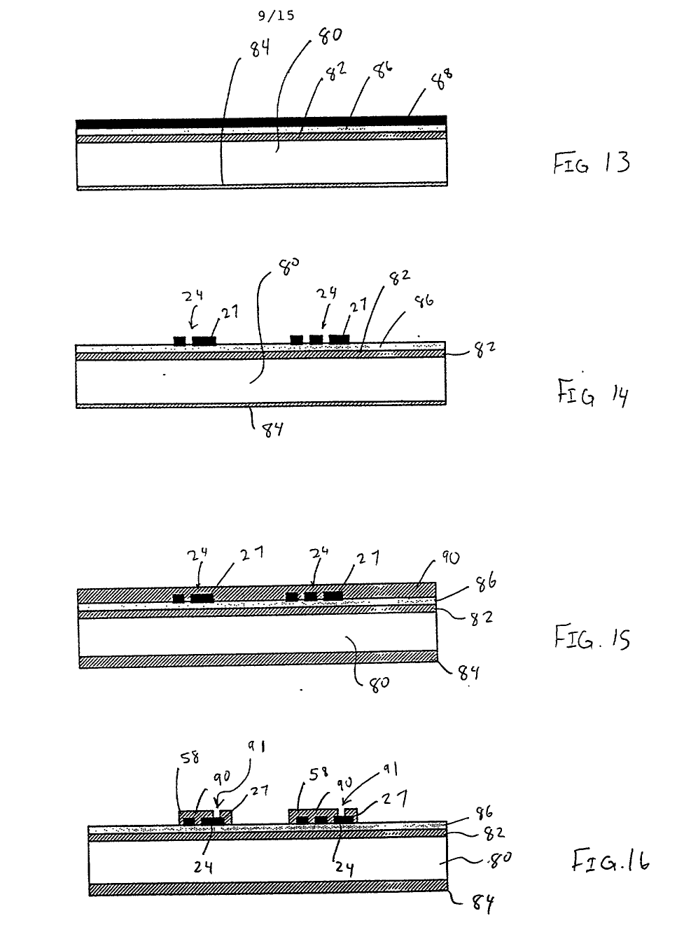

As best shown in FIGS. 1, 1A, 7, 7A and 8, the switch 10 of the present invention includes a transducer wafer 14 located on top of a circuit wafer 18. The transducer wafer 14 includes a transducer 12, and the circuit wafer 18 includes circuit 16 thereon. The circuit 16 may be a normally open circuit, and the transducer 12 is shaped and located to close the open circuit 16 when actuated.

The transducer 12 includes a base 20, an actuator 22 displaceably coupled to the base, and a conductive coil 24 located on the actuator. The actuator 22 is coupled to the base 20 by a set of flexible generally circumferentially extending arms 30, 32, 34, 36. The actuator 22 includes a ring portion 38 including a central opening 40 and a crossbar 42 spanning the central opening 40. The crossbar 42 includes an actuating surface 44 located on the lower surface of the crossbar (see FIGS. 7 and 8). It should be noted that FIGS. 7, 7A and 8 are cross sections of the switch of FIG. 1A; however, the cross section of the circuit wafer 18 is taken at a different location than the cross section of the transducer wafer 14, as indicated by the lines 7-7 of FIG. 1A. It should also be noted that the size of the central opening 40 in FIGS. 7, 7A and 8 has been reduced for illustrative purposes.

As shown in FIG. 7, the actuating surface 44 may include a layer of conductive material located on the lower surface of the crossbar 42, although the actuating surface need not necessarily include a conductive surface thereon, as shown in FIG. 8. The ring portion 38 of the actuator includes the coil 24 located on an upper surface of the actuator 22, and the actuating surface 44 is located on the lower surface of the actuator 22. Thus, the actuating surface 44 and coil 24 are located on opposite sides of the actuator 22. The coil 24 includes a pair of leads 50, 52 extending generally radially outwardly from the ring portion 38, each lead 50, 52 terminating in a bonding pad 54, 56.

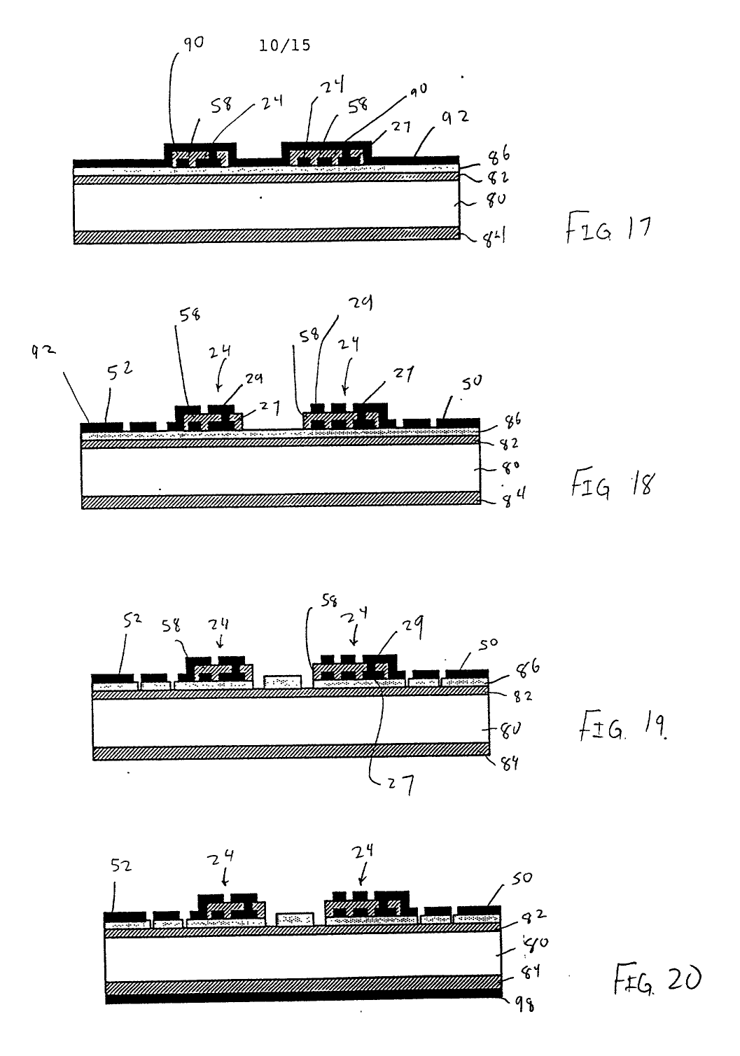

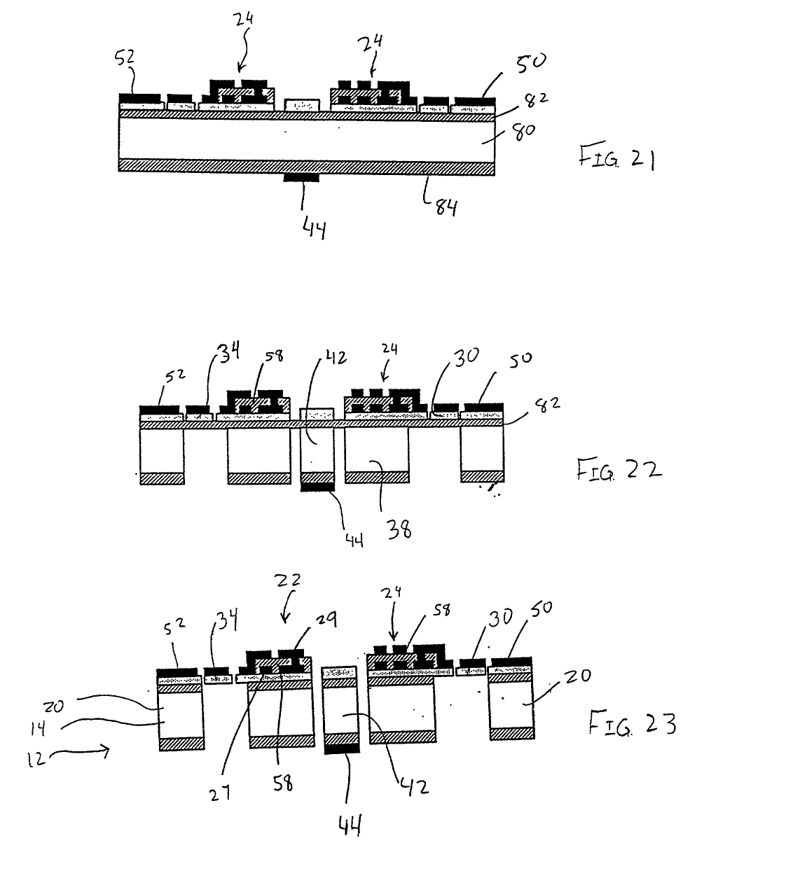

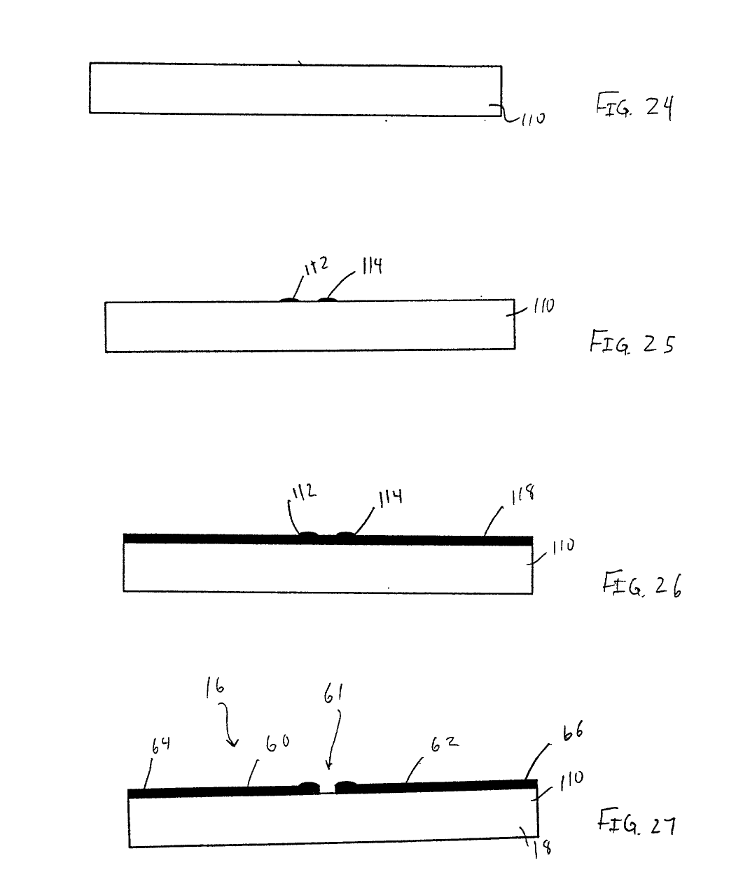

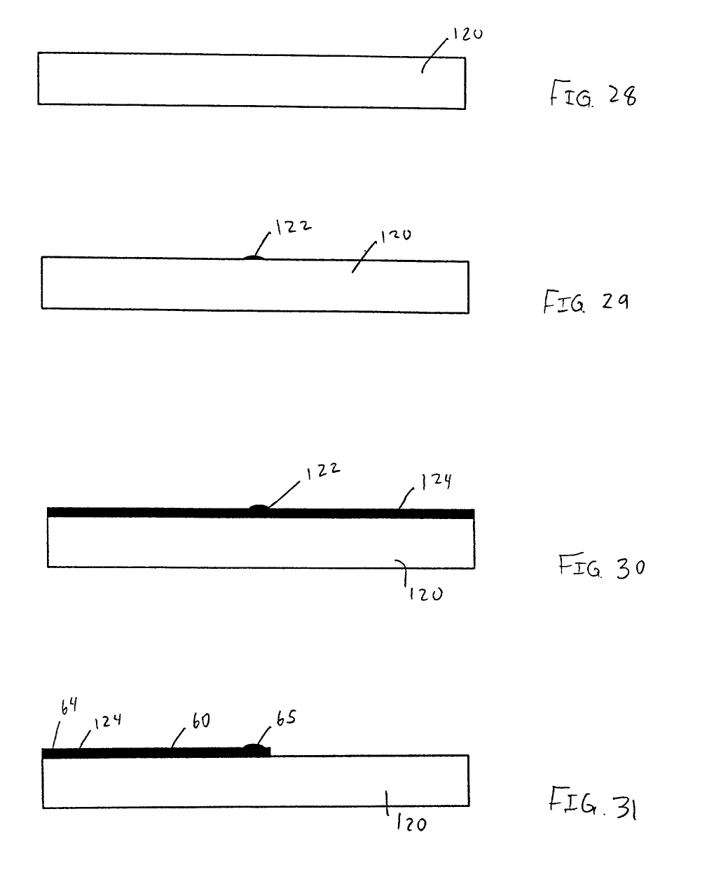

As best shown in FIGS. 1 and 1A, the arms 30, 32, 34 and 36 extend generally circumferentially around the ring portion 22. As will be discussed in greater detail below, the arms 30, 32, 34, 36 enable the actuator 22 to move in a radial sweeping motion to improve contact performance. A variety of other configurations for actuator 22 and its arms 30, 32, 34 and 36 are shown in FIGS. 3-6, although it should be understood that the invention is not limited to the particular arms and actuator illustrated herein. For example, non-arcuate arms, arms made of elastic materials, spring-arms, etc. or other couplings or structures (i.e., a flexible diaphragm) may be used in place of the illustrated arms without departing from the scope of the invention. The arms of the various embodiments in FIGS. 3-6 include differing lengths to enable the actuator 22 to be matched to the required deflection of the actuator 22.

Although FIG. 1 illustrates only a single layer of conductive material forming the coil 24, the coil may include a plurality of layers of conductors forming several stacked, connected coils to increase the actuation force exerted by the transducer 12. For example, the coil 24 may include two layers of conductors 27, 29 formed in a pair of stacked coils, as shown in FIGS. 7 and 7A. In this case, the coil layers 27, 29 are separated by an insulating layer 58. Any number of layers of coils may be formed, as each layer increases the actuation force. However, manufacturing tolerances, mechanical strength and weight considerations provide an upper limit to the number of layers of coils that may be used. Of course, each layer of the coil 24, as well as the leads 50, 52, should be electrically coupled to each other.

As best shown in FIGS. 1, 7 and 8, the transducer wafer 14 is located on a circuit wafer 18. The circuit wafer 18 has a circuit 16 formed thereon, including, in the illustrated embodiment, a first 60 and a second 62 electrical conductor with a gap 61 therebetween. Each conductor 60, 62 includes an associated bonding pad 64, 66. As shown in FIG. 8, the switch 10 may include a permanent rare earth ring magnet 70 that is located over the transducer 12, and more particularly, over the coil 24 of the actuator 22.

As best shown in FIGS. 7-8, the switch 10 includes a seal ring 72 located between the circuit wafer 18 and the transducer wafer 14. The seal ring 72 is typically quite thin (i.e., about 10-15 microns thick) and its thickness is exaggerated in FIGS. 7, 7A and 8 for illustrative purposes. The seal ring 72 is preferably made of frit glass, and forms a seal to prevent impurities (including water or moisture) from penetrating the switch 10. The seal ring 72 also acts as a bonding agent to adhere the circuit wafer 18 to the transducer wafer 14. The seal ring 72 is preferably bonded to the circuit wafer 18 and transducer wafer 14 to form a seal, yet enables the first and second conductors 60, 62 to pass under the seal ring without electrically shorting the conductors 60, 62, in a known manner. The switch 10 also preferably includes a top cap 74 (FIG. 8) located on top of the transducer 12. The top cap 74 seals the transducer 12 to prevent impurities from entering the inner chamber of the switch 10. The top cap 74 can be made from a variety of materials, including but not limited to silicon, glass, or nearly any other preferably machinable material, and may be frit glass bonded to the transducer wafer 14. The top cap 74 may be frit glass bonded to the transducer wafer 14 using a thermocompressive bond to seal the transducer 12, yet enables the leads 50, 52 to pass under the top cap without shorting the leads 50, 52. The seal ring 72 and top cap 74 together provide a hermetically sealed switch 10.

The top cap 74 preferably includes an upwardly-protruding portion 76, and the upwardly-protruding portion 76 is shaped to be closely received in the center opening 71 of the ring magnet 70. The upwardly-protruding portion 76 helps to locate the ring magnet 70 at the desired location. For example, it is advantageous to have the ring magnet 70 centered precisely over the coil 24 to maximize the magnetic forces in the switch 10, and to avoid the application of uneven magnetic forces upon the coil 24.

In operation, the switch 10 is used to selectively electrically couple the first and second conductors 60, 62 of the circuit wafer 18. In order to operate the switch 10, the switch 10 is placed in the presence of an external magnetic field, preferably by locating the magnet 70 adjacent to the transducer wafer 14 (see FIG. 8). However, the external magnetic field may be generated by other means, such as various other magnets, magnets in other locations than those specifically shown herein or by electromagnetic generation. An external, controllable current source (not shown) is then connected to the bonding pads 54, 56 of the coil 24. A pair of terminals of a line or conductor (not shown) to be controlled by the switch 10 are then connected to the bonding pads 64, 66 of the circuit wafer 18.

In order to operate the switch 10, a current is passed through the coil 24 by the current source, which generates a magnetic field around the coil 24. The generated magnetic field interacts with the magnetic field of the permanent magnet 70 to cause a repulsive magnetic force, which causes the coil 24 and actuator 22 to be displaced downwardly relative to the base 20 and magnet 70, as shown in FIG. 7A. The flexible nature of the arms 30, 32, 34, 36 enable the actuator 22 to be displaced relative to the base 20.

The actuator 22 is shown in its actuating position in FIG. 7A. When in this position, the conductive actuating surface 44 contacts both the first 60 and second 62 conductors, and thereby electrically couples the first 60 and second 62 conductors. When the actuator 22 is displaced, it is moved in a rotating sweeping motion due to the shape of the arms 30, 32, 34, 36. In other words, the actuator 22 rotates very slightly in the clockwise direction the FIG. 1 when the actuator 22 is lowered. This rotation or sweeping movement of the actuator helps to “grind” the actuating surface 44 into the conductors 60, 62, to create new asperities or points of contact and break through any debris or oxide on the actuating surface 44 or conductors 60, 62. This sweeping motion of the actuator 22 helps to reduce the contact resistance of the closed circuit.

In order to open the switch 40 and the circuit 16, the current passing through the coil 24 is terminated by the current source, and the actuator 22 returns to its position shown in FIG. 7 as biased by the spring force of the arms 30, 32, 34 and 36. Alternately, a current may be passed through the coil 24 in the opposite direction than that used to close the circuit 16. This causes the actuator to be displaced upwardly, or away from the circuit 16, and may be useful to ensure that the actuator 22 is completely spaced away from the circuit 16 and that the circuit is in its open condition. A reverse current can also be passed through the coil 24 if the actuating surface 44 becomes welded to the conductors 60, 62, such as by over powering, and the reverse current can usually separate the actuating surface 44 from the conductors 60, 62.

The switch 10 of the present invention may also be used with the circuit 16′ illustrated in FIG. 8. The circuit 16′ includes first 60 and second 62 spaced-apart conductors. The second conductor 62 includes a cantilevered portion 63 that is located above, and vertically spaced apart from, a contact bump 65 of the first conductor 60. In this embodiment, when the actuator 22 is moved to its actuating position, the actuating surface 44 engages the cantilevered portion 63 and presses it downwardly and into contact with the first conductor 60, thereby completing the circuit 16. In this case, of course, the actuating surface 44 need not be conductive. The circuit 16′ of FIG. 8 (a one-contact circuit) provides more force per contact and less contact resistance, whereas the circuit 16 of FIG. 7 (a two-contact circuit) is easier to fabricate. Of course, the switch 10 of the present invention can also be used with a variety of circuits or other electrical connections beyond the circuits illustrated herein.

In one embodiment, the inner diameter of the ring portion 38 is about 450 μm, the outer diameter of the ring portion 38 is about 650 μm, each turn of the coil 24 is about 8 μm wide. The spacing between each turn of the coil may be about 2 μm which results in a 40 turn coil on the ring portion (a low number of turns of the coil 24 are included in the drawings for clarity purposes). The seal ring may be about 5-25 microns thick, and the conductive material on the actuating surface 44 may be rhenium. Each of the four arms 30, 32, 34, 36 may have a width of about 100 μm, a thickness of about 2 μm, extend for about 22.5 degrees, and have a spring constant of about 34 N/m. The rare earth ring magnet 70 may have a thickness of about 1 mm, an inner diameter of about 1.2 mm, and an outer diameter of about 3.2 mm. In this embodiment the coil 24 at about 15 mA results in about 0.6 amp turns of current, which is projected to result in about 1 mN in magnetic force during actuation of the sensor. The coil 24 and leads 50, 52 may be made of aluminum, although various other metals, such as gold, rhenium or other low resistance materials may be used. The conductive lines 50, 52, 60, 62 may each has a width of about 0.2 mm, and the gap between the contacts 61 may be about 10 μm. With this coil layout and using 2 μm thick aluminum as coil metal, the coil resistance is between about 216 Ω and about 431 Ω depending upon the metal etching method. The power consumed by the coil is expected to be about 48.5 mW to 97 mW, although this can be improved if a thicker coil metal is used. With a 1 mN magnetic force the contact resistance of the closed switch is estimated to be about 100 mΩ. It is also estimated that a time of about 50 μs is required to close the switch. Thus, a relatively high actuation force can be delivered over a large distance, both in closing and opening the actuator.

In yet another embodiment, the dimensions of the ring portion, seal ring, arms, conductive material, magnet and conductive lines are identical to that in the embodiment above, and only the layout of the coil is changed. In this embodiment, each turn of the coil is about 17 μm wide, and the spacing between each turn of the coil is about 8 μm, and the coil includes about 13.5 turns. In this embodiment, the coil at about 44 mA results in about 0.6 amp turns of current and a coil resistance of between about 60 Ω and 70 Ω. The power consumed by the coil in this embodiment is expected to be about 128 mW and to produce about 1 mN of magnetic force.

Accordingly, the switch 10 of the present invention provides a responsive and robust switch for completing electrical connections in a circuit. Because the coil 24 is located on an upper surface of the transducer wafer 14, and the actuating surface 44 is located on the lower surface of the transducer wafer, and first and second conductors 60, 62 are located on the circuit wafer 18, the coil 24 is physically spaced from the actuating surface 44 and the first and second conductors 60, 62. Thus, the magnetic field generated by the coil 24, as well as the magnet 70 and the magnetic field, are physically separated from the circuit 16 by a relatively large distance. This helps to reduce the adverse effect the magnetic fields may have upon a signal transmitted by the circuit 16 as well as isolating the coil 24 electric signal from the RF contact circuit 16.

Another advantage of the switch 10 of the present invention is that the magnetic forces generated by the switch are relatively strong over relatively high distances. In other words, the magnetic forces exerted on the actuator are relatively strong for the entire range of motion of the actuator. This is due to the fact that the generated magnetic forces drop only linearly with respect to distance, as compared to electrostatic forces which drop exponentially with increasing distance.

The signals to be transmitted by the circuit 16 may be high frequency signals, such as RF signals. Because the magnetic forces generated by the switch are relatively high, the actuator 22 can remain spaced a relatively large distance from the circuit wafer 18. In other words, the distance A of FIG. 7 can be relatively large due to the relatively strong magnetic forces generated by the switch of the present invention. Thus, because the actuator 22 and its actuating surface 44 are spaced apart from the circuit 16 by the relatively large distance A, the capacitance between the circuit 16 and the actuating surface 44 or any other portions of the switch, are reduced. Thus, the parasitic effects of the actuator 22 and its actuating surface 44 upon the circuit 16 are reduced, thereby improving the operating characteristics of the switch.

The central opening 40 of the actuator 22 enables air or other fluid inside the switch 10 to pass through the opening 40 during movement of the actuator 22, which reduces damping of the actuator. The central opening 40 also reduces the mass of the actuator 22 to provide a quick actuation time.

Because the switch 10 is formed on a pair of stacked wafers 14, 18, a plurality of switches can be batch processed on a single wafer or wafers. Furthermore, each switch can be “hard-wired” by forming electrical connections between switches during formation of the switches. This enables a series of switches to be connected together and controlled by a single controller. By electrically connecting the switches together during manufacturing, the number of connections that need to be made by the end user is significantly reduced. For example, the plurality of switches can be connected together with multiplexing circuitry. In other words, a plurality of switches can be electrically connected in various patterns and in association with hard wired logic circuitry to control the switches individually or in larger numbers.

FIGS. 9-23 illustrate a preferred method for forming the transducer wafer 14 of the switch 10 of FIGS. 1, 1A, 7 and 8 although various other methods of forming the switch may be used without departing from the scope of the invention. The transducer wafer 14 (as well as the circuit wafer 18) are preferably batch processed such that a plurality of transducer wafers (or circuit wafers) are formed on a single, larger wafer or wafers simultaneously primarily to reduce manufacturing costs. However, for ease of illustration, FIGS. 9-23 illustrate only a single transducer wafer 14 being formed. Similarly, FIGS. 24-36 illustrate the processing step for only a single circuit wafer 18. It should be understood that the manufacturing steps illustrated herein are only one way in which the switch of the present invention may be manufactured, and the order and details of each step described herein may vary, or other steps may be used or substituted.

As shown in FIG. 9, the process begins with a double-side polished high resistivity silicon wafer 80 (which will ultimately be the transducer wafer 14). However, the wafer may also be made of other materials, including but not limited to polysilicon, amorphous silicon, glass, silicon carbide, germanium, ceramics, nitride, sapphire, and the like. Furthermore, nearly any material, preferably a material that is machinable and flexible, may be used as the base material of the wafer. An upper oxide layer 82 and a lower oxide layer 84 (such as silicon dioxide, each preferably about 1 μm thick) or other insulating layers are then formed on both sides of the wafer (FIG. 10). Next, a substrate layer 86 is formed on both of the oxide layers 82, 84 (FIG. 11). The substrate layer 86 is preferably about 2 μm thick polysilicon, although other materials, including but not limited to single crystal silicon, amorphous silicon, glass, silicon carbide, germanium, polyimide, ceramics, nitride, sapphire and the like may be used. Furthermore, nearly any material, preferably a material that is machinable and flexible, may be used as the substrate layer 86. The lower substrate layer is then removed (FIG. 12).

Alternately, a silicon-on-insulator (SOI) wafer may be used in place of the wafer 80 of FIG. 9, in which case the process proceeds by processing the SOI wafer as illustrated in steps 13-23 below.

As shown in FIG. 13, a first layer of conductive material 88, including but not limited to aluminum, rhenium, copper, doped silicon or polysilicon, gold, or a variety of other metals is then sputtered onto the upper substrate layer 86. The first conductive layer 88 is preferably about 2 μm thick. Next, the first conductive layer 88 is patterned to form the first layer 27 of the coil 24. Because the switch 10 formed in the illustrated manufacturing steps includes a two-layer coil 24, an isolation layer 90, including but not limited to SiO₂, polyimid, silicon nitride, SIOₓN_{Y} (i.e. any of a variety of combinations of Si and O and N) or other materials is then deposited onto the first layer 27 of the coil 24 (FIG. 15). The isolation layer 90 is then patterned (FIG. 16) to remove the portions of the isolation layer that are not located over the coil 24 so that the isolation layer is located only over the coil 24, and thereby forms the insulating layers 58. The isolation layer 90 is also patterned such that the insulating layers 58 include a set of contact holes 91 which expose a portion of the first layer 27 of the coil 24.

Next, a second conductive layer 92 is sputtered over the exposed substrate layer 86 and the insulating layers 58 (FIG. 17). The second conductive layer 92 is deposited such that it passes through the contact holes 91 in the insulating layer 58 and contacts the first layer 27 of the coil 24. Next, as shown in FIG. 18, the second conductive layer 92 is patterned to form the second layer 29 of the coil 24, the leads 50, 52, and the associated bonding pads 54, 56.

The first 27 and second layers 29 of the coil 24 are preferably formed by the steps shown in FIGS. 13-18. However, it is expected that the Dual-Damascene process (a common industry process) for depositing multiple layers of metal interconnect on wafer may also be used for depositing a multi-layer coil, typically of thick copper construction.

Next, as shown in FIG. 19, the substrate layer 86 is patterned, such as by deep reactive ion etching (“DRIE”) to define the upper outer edges of the arms 30, 32, 34, 36, ring portion 38, cross bar 42, and central opening 40 of the actuator 22. The use of DRIE, which is a highly directional etching process, enables accurate etching through a relatively thick substrate layer 86.

As shown in FIG. 20, a third conductive layer 98 is deposited on to the lower oxide layer 84, preferably by sputtering. The third conductive layer 98 is then patterned (FIG. 21) to form the actuating surface 44 that will ultimately be located on the lower end of the cross bar 42 of the actuator 22. The steps of FIGS. 20 and 21 may be omitted if the actuator is not required to have a conductive actuating surface 44.

Next, as shown in FIG. 22, the bulk of the wafer 80 (that is, the silicon layer 80) is etched to etch away the bulk portions located below the arms 30, 32, 34, 36, and to etch the bulk portions of the ring portion 38 and cross bar 42 of the actuator 22. Highly directional etching, such as DRIE is preferably used. Highly directional etching enables the thickness of the actuator 22 to be relatively large, which helps to physically separate the coil 24 from the actuating surface 44 and circuit 16, providing the advantages discussed above. Finally, as shown in FIG. 23, the exposed portions of the upper oxide layer 82 are removed, such as by a dry etch, to release the arms 30, 32, 34, 36 and actuator 22 and open up the central opening 40 of the actuator.

FIGS. 24-27 illustrate one method that may be used to form the circuit 16 used with the switch 10 of the present invention. As shown in FIG. 24 the process begins with a wafer 110, such as a double-side polished silicon wafer 110 (which will ultimately be the circuit wafer 18). A set of contact bumps 112, 114 (FIG. 25) are then deposited on the wafer 110. The bumps 112, 114 may be made of a wide variety of material, such as metal or silicon, or even non-conductive materials. Next, a conductive layer 118 (preferably about 2-5 μm thick) is sputtered on top of the wafer 110 and bumps 112, 114 (FIG. 26). Finally, as shown in FIG. 27, the conductive layer 118 is patterned to form the first and second conductors 60, 62, gap 61, and bonding pads 64, 66.

FIGS. 28-36 illustrate one method that may be used to form the alternate circuit 16′ illustrated in FIG. 8 that may be used with the switch 10 of the present invention. The process begins with a wafer 120, such as a double-side polished silicon wafer 120 (which will ultimately be the circuit wafer 18). A base bump 122 is formed on the wafer (FIG. 29), and a first conductive layer 124 is deposited over the wafer 120 and base bump 122 (FIG. 30). The first conductive layer 124 is patterned to form the contact bump 65, first conductor 60 and bonding pad 64 (FIG. 31).

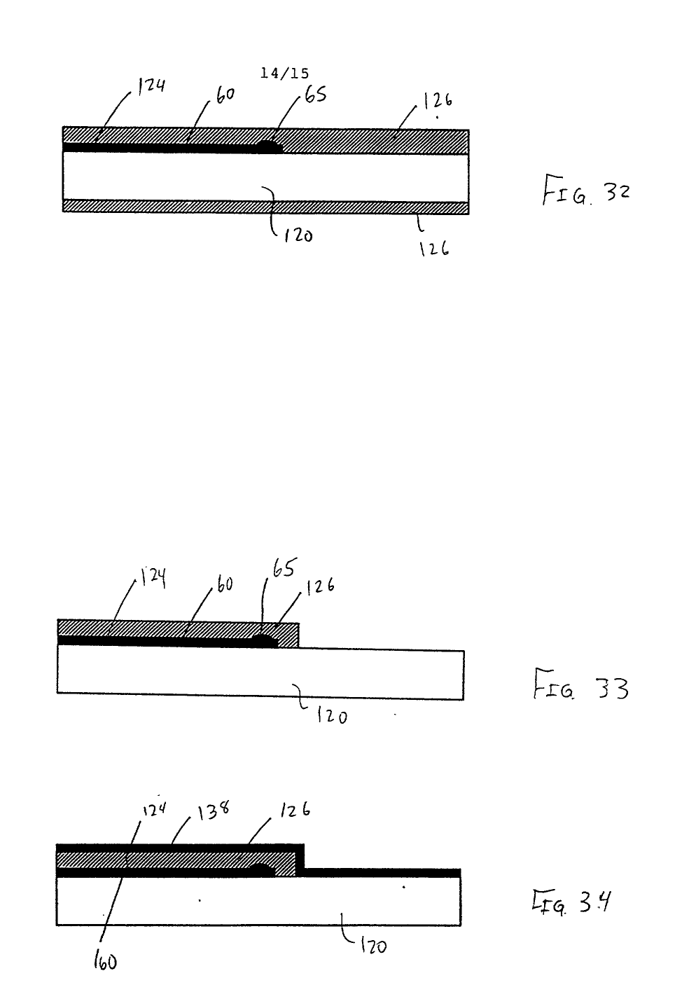

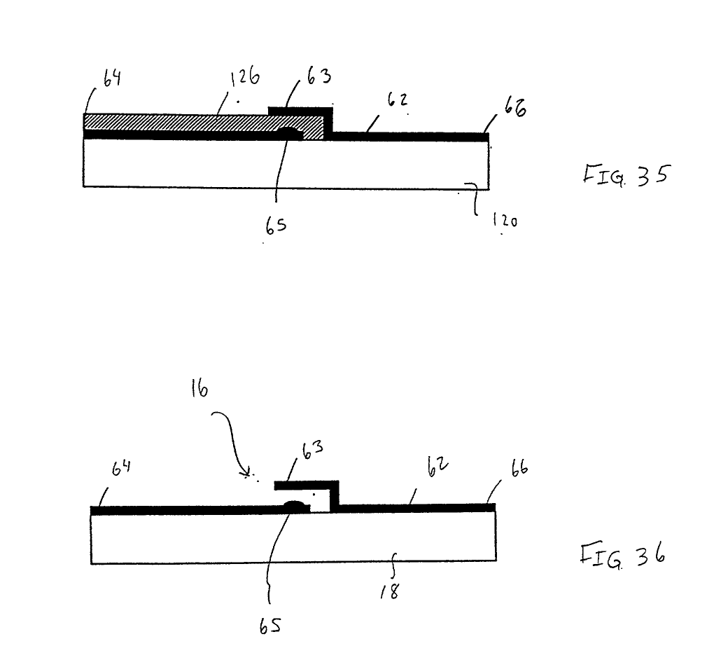

Next, an isolation or sacrificial layer 126 is located over the first conductive layer 124 and the wafer 120, and the top surface of the isolation layer is planarized (FIG. 32). The isolation layer 126 is then patterned (FIG. 33) and removed from the lower surface of the wafer 120. A second conductive layer 138 is deposited over the isolation layer 126 and wafer 120 (FIG. 34). The second conductive layer 138 is then patterned to form the second conductor 62, the cantilevered portion 63, and associated bonding pad 66 (FIG. 35). Finally, the isolation layer 126 is removed to expose the circuit 16′ (FIG. 36).

After the transducer 10 and associated circuit 16 or 16′ are formed, the circuit wafer 18 is bonded to the transducer wafer 14 via the seal ring 72 to form the switch 10 as shown in FIGS. 7 and 8. The first and second (internal) conductors 60, 62 can then be coupled to first and second conductors (not shown) of an external device, for example, by bonding the first and second conductors to the bonding pads 64, 66. A controllable current source (not shown) may be coupled to the coil 24 at bonding pads 54, 56. In this manner the switch 10 can control a current or signal being passed through the external conductors by opening or closing the circuit 16 on the circuit wafer 18.

Having described the invention in detail and by reference to the preferred embodiments, it will be apparent that modifications and variations thereof are possible without departing from the scope of the invention.

What is claimed is:

1. A switch comprising:
a first and a second conductor; and
a transducer including a base and an actuator coupled to said base, said actuator including an actuating surface and a coil located thereon such that when said switch is located in a magnetic field and a sufficient current is passed through said coil, said actuator is displaced relative to said base to an actuating position wherein said actuating surface causes said first and second conductors to be electrically coupled.

2. The switch of claim 1 wherein said actuating surface is a conductive surface.

3. The switch of claim 1 wherein said actuating surface and said coil are located on opposite sides of said actuator.

4. The switch of claim 3 wherein said coil is located on an upper surface of said actuator and said actuating surface is located on a lower surface of said actuator.

5. The switch of claim 1 wherein said transducer includes a plurality of flexible arms extending between said base and said actuator to enable said actuator to be displaced relative to said base.

6. The switch of claim 5 wherein said actuator includes a ring portion having a central opening, and wherein said coil is located on said ring portion.

7. The switch of claim 6 wherein each arm extends generally circumferentially relative to said ring portion.

8. The switch of claim 6 wherein said actuator includes a cross bar extending across said central opening, and wherein said actuating surface is located on a lower surface of said cross bar.

9. The switch of claim 1 wherein said actuator is an electrical insulator.

10. The switch of claim 1 wherein said base and said actuator are each made from a wafer of material.

11. The switch of claim 1 further comprising a permanent magnet mounted onto said transducer.

12. The switch of claim 1 further comprising a top cap located on said transducer to seal an upper surface of said transducer.

13. The switch of claim 12 wherein said top cap includes an upwardly protruding portion and wherein the switch further includes a magnet located on said top cap, said magnet having an opening receiving said upwardly protruding portion therethrough to locate said magnet at a predetermined position on said top cap.

14. The switch of claim 1 wherein said actuator includes an opening to enable fluid to flow through said opening during movement of said actuator.

15. The switch of claim 1 further including a magnetic field source and wherein said first and second conductors and said actuator are located inside a magnetic field generated by said magnetic field source.

16. The switch of claim 1 wherein said first and second conductors include a gap therebetween, and wherein said actuating surface is conductive surface and wherein said actuating surface simultaneously contacts both of said first and said second conductors to electrically couple said first and second conductors when said actuating surface is in said actuating position.

17. The switch of claim 1 wherein said first and second conductors include a gap therebetween and wherein said actuating surface contacts said first conductor and causes said first conductor to contact said second conductor when said actuating surface is in said actuating position.

18. The switch of claim 1 wherein said first and second conductors are located on a circuit wafer and said transducer is located on a transducer wafer, and wherein said circuit wafer is coupled to said transducer wafer.

19. The switch of claim 18 further comprising a seal ring located between said transducer wafer and said circuit wafer.

20. The switch of claim 1 wherein said first and second conductors each include a bonding pad, and wherein said coil includes a pair of bonding pads at each end of said coil, said bonding pads providing surfaces to enable said switch to be connected to external devices.

21. The switch of claim 1 wherein said coil includes at least two stacked layers of conductive material formed in a coil, said stacked layers being separated by an insulating layer.

22. The switch of claim 1 wherein said actuating surface is rotated relative to said first and second conductor when said actuator is displaced.

23. The switch of claim 1 wherein a current can be passed through said coil to displace said actuator away from said first and second conductors.

24. A switch comprising:
a first and a second conductor having a gap therebetween; and
a transducer including a base an actuator coupled to said base, said actuator including an actuating surface located on a first surface of said actuator, said actuator being displaceable relative to said base to an actuating position wherein said actuator can electrically couple a first and a second conductor, said actuator including a coil located on an opposite side of said actuator relative to said actuating surface.

25. The switch of claim 24 wherein said actuating surface is a conductive surface.

26. A micro-switch comprising:
a first and a second conductor;
a transducer including a base and an actuator coupled to said base, said actuator including an upper surface having a coil located thereon and a lower surface having an actuating surface located thereon, said transducer including a central opening and plurality of flexible generally circumferentially-extending arms extending between said base and said actuator to enable said actuator to be displaced relative to said base, said transducer further including a top cap located on said transducer to seal said transducer; and
a magnet located on said top cap, wherein when a sufficient current is passed through said coil, said actuator is displaced relative to said base due to the interaction of the magnetic field generated by said coil and said magnet to an actuating position wherein said actuating surface contacts at least one of said first and second conductors to cause said first and second conductors to be electrically coupled.

27. A method for controlling the flow of current through a circuit comprising the steps of:
providing a circuit including a first and a second conductor;
providing a transducer having a base and an actuator coupled to said base, said actuator including a coil and an actuating surface;
locating said transducer in a magnetic field; and
selectively passing a current through said coil such that said actuator is displaced relative to said base to an actuating position wherein said actuating surface causes said first and second conductors to be electrically coupled.

28. The method of claim 27 wherein said locating step includes locating a permanent magnet adjacent to said transducer.

29. The method of claim 27 wherein said transducer includes a first internal conductor and a second internal conductor, and wherein the method further includes the step of coupling said first conductor to said first internal conductor and coupling said second conductor to said second internal conductor, and wherein said actuating surface causes said first and second internal conductors to be electrically coupled during said passing step.

30. A method for manufacturing a transducer comprising the steps of:
providing a transducer wafer of material;
locating a first layer of conductive material on said wafer;
patterning said first layer of conductive material to form a coil; and
etching said transducer wafer to form a base and an actuator, said actuator including said coil thereon and being movable relative to said base.

31. The method of claim 30 further comprising the step of locating a substrate layer on said transducer wafer after said providing step, and wherein the method further includes the step of etching said substrate layer and said transducer wafer to form a set of arms in said substrate layer, each arm extending from said base to said actuator.

32. The method of claim 30 further comprising the step of locating a substrate layer on a top surface said transducer wafer after said providing step, and wherein said etching step includes etching the back side of said transducer wafer to expose said substrate layer such that said substrate layer couples said base and said actuator.

33. The method of claim 32 further comprising the step of etching said substrate layer to define a set of arms that extend between said base and said actuator before said wafer etching step.

34. The method of claim 33 wherein said transducer wafer is silicon and said substrate layer is polysilicon.

35. The method of claim 33 wherein said transducer wafer is a silicon-on-insulator wafer.

36. The method of claim 30 further comprising the steps of, after said patterning step:
depositing an isolation layer over said coil;
patterning said isolation layer to form an opening in said isolation layer that is located over said coil;
depositing a second conductive layer over said transducer wafer and said isolation layer such that at least part of said second conductive layer extends through said opening and contacts said coil; and
patterning said second conductive layer to form a second layer of said coil.

37. The method of claim 36 further comprising the steps of locating a third layer of conductive material on a lower surface of said transducer wafer and patterning said third layer of conductive material, and wherein said actuator include at least part of said third layer of conductive material thereon.

38. The method of claim 37 wherein said coil and said third layer of conductive material are located on an opposite side of said actuator.

39. The method of claim 30 further including the step of providing an circuit wafer having a first and a second conductor thereon, said first and second conductors including a gap therebetween, the method including the step of coupling said transducer wafer to said circuit wafer such that said actuator is located above said gap.

40. The method of claim 39 further including the step of locating a seal ring between said circuit wafer and said transducer wafer.

41. The method of claim 30 further comprising the step of locating a top cap on said transducer wafer to seal an upper surface of said transducer wafer.

42. The method of claim 41 wherein said top cap includes a upwardly-extending protrusion, and wherein the method includes the step of locating a ring magnet over said top cap such that said upwardly-extending protrusion is received in a central opening of said ring magnet.
